(19) United States
(12) Patent Application Publication
(10) Pub. No.: US 2013/0113767 A1
(43) Pub. Date: May 9, 2013

(54) IMAGE DISPLAY DEVICE, IMAGE DISPLAY METHOD, AND INTEGRATED CIRCUIT

(71) Applicants: Katsuhiko Hayashi, Nara (JP); Shinichi Shikii, Nara (JP); Keiji Sugiyama, Kyoto (JP)

(72) Inventors: Katsuhiko Hayashi, Nara (JP); Shinichi Shikii, Nara (JP); Keiji Sugiyama, Kyoto (JP)

(21) Appl. No.: 13/808,917

(22) PCT Filed: Apr. 26, 2012
(86) PCT No.: PCT/JP2012/002868

§ 371 Date: Jan. 8, 2013

(30) Foreign Application Priority Data
May 10, 2011 (JP) 2011-105698

(51) Int. Cl. G03B 21/14

(52) U.S. Cl. 345/207; 345/690

(57) ABSTRACT

An image display device including a light source, an image display unit including plural pixels, a deflection unit which includes plural regions and deflects, for each of the plural regions, a light beam traveling from the light source toward the image display unit, and a light control unit which controls the deflection unit to cause each of light beams passing through a corresponding one of the regions of the deflection unit to be deflected toward one of a first point and a second point that are different from each other, according to a pixel value of the pixel corresponding to the region.

### TECHNICAL FIELD

The present invention relates to an image display device for displaying an image such as a liquid crystal display, a display projection device such as a projector, and so on.

### BACKGROUND ART

An element using liquid crystals and an element using surface tension between adjacent materials having different refractive indices (for example, Electrowetting) have been known as elements which can actively control behavior of light.

Patent literature (PTL) 1 discloses the following technique related to a front lamp for an automobile. More specifically, PTL 1 discloses scanning light using a change in refractive index of a liquid-crystal prism (i) which includes two non-parallel transparent substrates facing each other and having transparent electrodes and alignment films, and (ii) in which liquid crystals are filled between the two transparent substrates.

PTL 2 discloses a directional illumination unit for an auto-stereoscopic display. More specifically, PTL 2 discloses a device which includes a surface-emitting illumination unit and an imaging unit and collects light by causing the light to be deflected by electrowetting cells arranged in a matrix, according to a position of an observer. It should be noted that the electrowetting cell is a cell for controlling liquid surface tension using electrostatic potential to control refractive power of light.

### CITATION LIST

### Patent Literature

[PTL 1] Japanese Unexamined Patent Application Publication No.

[PTL 2] Japanese Unexamined Patent Application Publication (Translation of PCT Application) No. 2010-529485

### SUMMARY OF INVENTION

### Technical Problem

Recently, it is required to improve contrast of an image display device.

The present invention was conceived in view of this, and has object to provide an image display device with improved contrast.

### Solution to Problem

An image display device according to an embodiment of the present invention includes a light source, an image display unit which includes plural pixels and controls, for each of the plural pixels, an amount of a light beam passing through the pixel, the light beam being emitted from the light source, a deflection unit which includes plural regions and deflects, for each of the plural regions, a light beam traveling from the light source toward the image display unit, and a light control unit which controls the deflection unit to cause each of light beams passing through a corresponding one of the regions of the deflection unit to be deflected toward one of a first point and a second point, according to a pixel value of the pixel corresponding to the region, the first point and the second point being different from each other.

It should be noted that these general or specific aspects may be implemented by a system, a method, an integrated circuit, a computer program, a recording medium, or any combination of them.

### Advantageous Effects of Invention

According to the present invention, a high-contrast image display device can be provided.

### BRIEF DESCRIPTION OF DRAWINGS

FIG. 1 illustrates a perspective view showing appearance of an image display device according to an embodiment 1.

FIG. 2 illustrates a functional block diagram showing the image display device according to the embodiment 1.

FIG. 3 illustrates a configuration of a light source, a deflection unit, and an image display unit.

FIG, 4 illustrates a specific structure of the deflection unit.

FIG. 5A illustrates an example of the deflection unit divided into plural regions.

FIG. 5B illustrates another example of the deflection unit divided into plural regions.

FIG. 6 illustrates a flow chart showing an image display method according to the embodiment 1.

FIG. 7 illustrates light-collecting positions for light beams passing through the respective regions of the deflection unit when a set of pixels B in the image display unit appears black (luminance is less than a predetermined threshold).

FIG. 8 illustrates light-collecting positions for light beams emitted from an image display device according to an embodiment 2.

FIG. 9 illustrates light-collecting positions for the light beams passing through the respective regions of the deflection unit when a set of pixels D in the image display unit appears black (luminance is less than a predetermined threshold).

FIG. 10 illustrates a perspective view showing one of regions of a set of a first sub-deflection unit and a second sub-deflection unit.

FIG. 11 illustrates an example of a region of the deflection unit, which is divided into sub-regions each provided for a corresponding one of sub-pixels.

### DESCRIPTION OF EMBODIMENTS

Conventional techniques as described above fail to mention a control method according to characteristics of an image displayed on a display device, such as a method of controlling deflection of a light beam or a method of controlling illumination for an image. The techniques also fail to mention an illumination distribution state in an illumination area actually illuminated, or a state or quality of sharpness of an image obtained by actually focusing a displayed image on a retina.

In the control of the light beam, a driving method and a deflection direction of the light beam passing through each divided area should be effectively controlled according to the displayed image. When they are not controlled appropriately, an image quality is significantly degraded.

In order to solve such a problem, an image display device according to an embodiment of the present invention includes a light source, an image display unit which includes plural pixels and controls, for each of the plural pixels, an amount of a light beam passing through the pixel, the light beam being emitted from the light source, a deflection unit which includes plural regions and deflects, for each of the plural regions, a light beam traveling from the light source toward the image display unit, and a light control unit which controls the deflection unit to cause each of light beams passing through a corresponding one of the regions of the deflection unit to be deflected toward one of a first point and a second point, according to a pixel value of the pixel corresponding to the region, the first point and the second point being different from each other.

According to the above configuration, a high-contrast image display device can be provided by controlling a direction of the light beam passing through each of the regions of the deflection unit according to a pixel value of each of pixels in the image display unit.

For example, the light control unit may cause a first light beam and a second light beam to be deflected toward the first point and the second point, respectively, the first light beam being a light beam passing through the region corresponding to the pixel having a luminance value not less than a predetermined threshold, and the second light beam being a light beam passing through the region corresponding to the pixel having a luminance value less than the threshold.

In other wards, the light beam passing through a region corresponding to a black pixel or an almost black pixel is deflected toward the second point, and the light beam passing through a region corresponding to a color pixel other than the black pixel or the almost black pixel should be deflected toward the first point.

Moreover, the image display device may further include a detection unit which detects an eye position of a viewer. The light control unit may determine the eye position of the viewer detected by the detection unit as the first point, and a position outside positions of both eyes of the viewer as the second point.

With this, light beams that ideally should not enter into both eyes of the viewer (for example, light leaking from the black pixel) are deflected toward the position outside positions of the eyes of the viewer, and thus the high-contrast image display device can be provided.

In addition, the image display device may alternately display a right-eye image and a left-eye image which have disparity. The light control unit may determine a right-eye position of the viewer detected by the detection unit as the first point at a time when the right-eye image appears and determine a left-eye position of the viewer detected by the detection unit as the first point at a time when the left-eye image appears.

With this, a three-dimensional image can be displayed without using an active shutter glasses or the like.

In addition, the deflection unit may include a first sub-deflection unit which deflects, in a first direction, the light beam emitted from the light source and a second sub-deflection unit which deflects, in a second direction, the light beam having passed through the first sub-deflection unit, the second direction being a direction crossing the first direction.

With this, the light beam passing through each region of the deflection unit can be deflected toward any position in three-dimensional space.

In addition, the region may include n sub-regions each provided for a corresponding one of n sub-pixels of the pixel, n being an integer not less than 2. The light control unit may separately control deflection angles of the n sub-regions to cause each of light beams passing through a corresponding one of the n sub-regions to be deflected toward the first point.

With this, a displacement of a deflection angle caused by a different frequency of the light beam passing through each sub-pixel is absorbed, and all-colored light beams can be collected to the first point. As a result, the high-contrast image display device can be provided.

For example, the image display unit may be a liquid crystal panel

For example, the deflection unit may control a deflection direction by changing orientations of liquid crystal molecules.

For example, the image display device may include a plurality of the light sources. The image display unit may include the plural pixels, the total number of which is more than or equal to ten times the total number of the light sources.

An image display method according to an embodiment of the present invention causes an image display device to display an image, the image display device including: a light source; an image display unit which includes plural pixels and controls, for each of the plural pixels, an amount of a light beam passing through the pixel from the light source; and a deflection unit which includes plural regions and deflects, for each of the plural regions, a light beam traveling from the light source toward the image display unit, This image display method includes controlling the deflection unit to cause each of light beams passing through a corresponding one of the regions of the deflection unit to be deflected toward one of a first point and a second point, according to a pixel value of the pixel corresponding to the region, the first point and the second point being different from each other.

An integrated circuit according to an embodiment of the present invention causes an image display device to display an image, the image display device including: a light source; an image display unit which includes plural pixels and controls, for each of the plural pixels, an amount of a light beam passing through the pixel from the light source; and a deflection unit which includes plural regions and deflects, for each of the plural regions, a light beam traveling from the light source toward the image display unit. This integrated circuit includes a light control unit which controls the deflection unit to cause each of light beams passing through a corresponding one of the regions of the deflection unit to be deflected toward one of a first point and a second point, according to a pixel value of the pixel corresponding to the region, the first point and the second point being different from each other.

It should be noted that these general or specific aspects may be implemented by a system, a method, an integrated circuit, a computer program, a recording medium, or any combination of them.

The following paragraphs describe embodiments of the present invention with reference to drawings. It should be noted that each of the embodiments described below is a specific example of the present invention. The numerical values, shapes, constituent elements, the arrangement and connection of the constituent elements, steps, the processing order of the steps etc. shown in the following embodiments are mere examples, and thus do not limit the present invention. Thus, among the constituent elements in the following embodiments, constituent elements not recited in any of the independent claims indicating the most generic concept of the present invention are described as preferable constituent elements.

### Embodiment 1

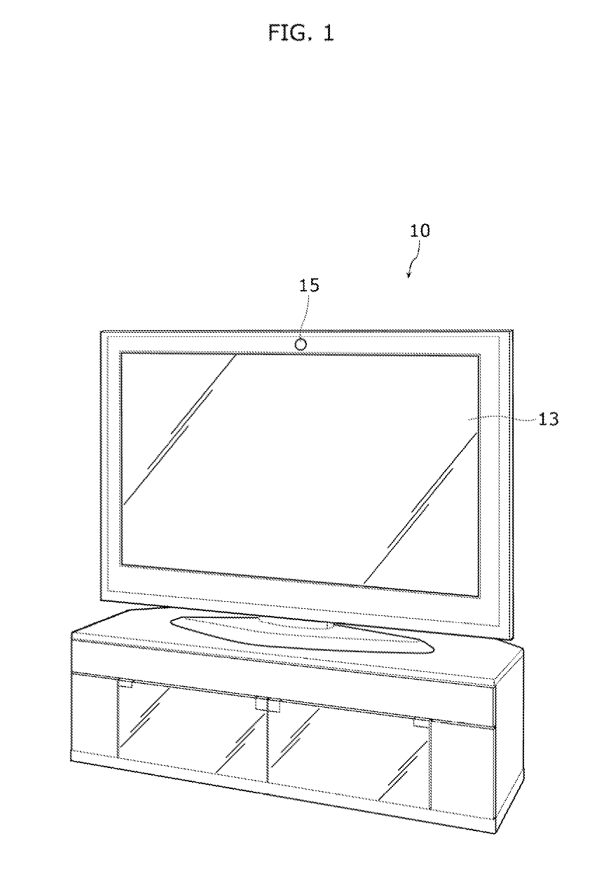

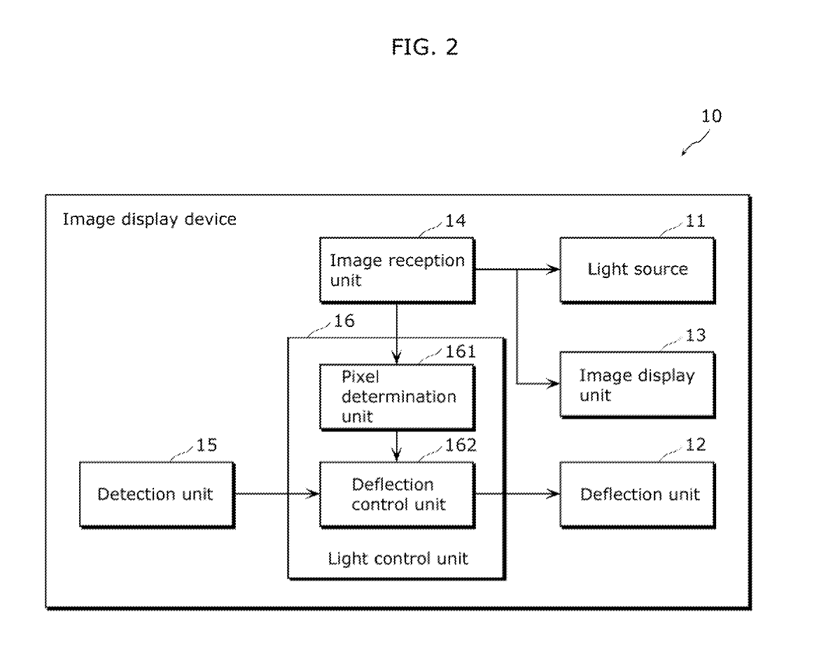

An image display device according to an embodiment 1 is described with reference to FIG. 1 to FIG. 5B, FIG. 1 illustrates a perspective view showing appearance of the image display device 10 according to the embodiment 1, FIG. 2 illustrates a functional block diagram showing the image display device 10 according to the embodiment 1.

As shown in FIG. 1, a typical example of the image display device 10 according to the embodiment 1 is a television set. It should be noted that the present invention is not limited to this and can be applied to various image display devices such as a mobile phone and a personal computer. The image display device 10 according to the embodiment 1 mainly includes a light source 11, a deflection unit 12, an image display unit 13, an image reception unit 14, a detection unit 15, and a light control unit 16, as shown in FIG. 2.

The light source 11 emits light and serves as a back light of the image display device 10. In other words, the light beam emitted from the light source 11 passes through the deflection unit 12 and the image display unit 13 and then goes out of the image display device 10, The light source 11 is not particularly limited to a specific structure, but may be a laser light source or a Light Emitting Diode (LED) source for example.

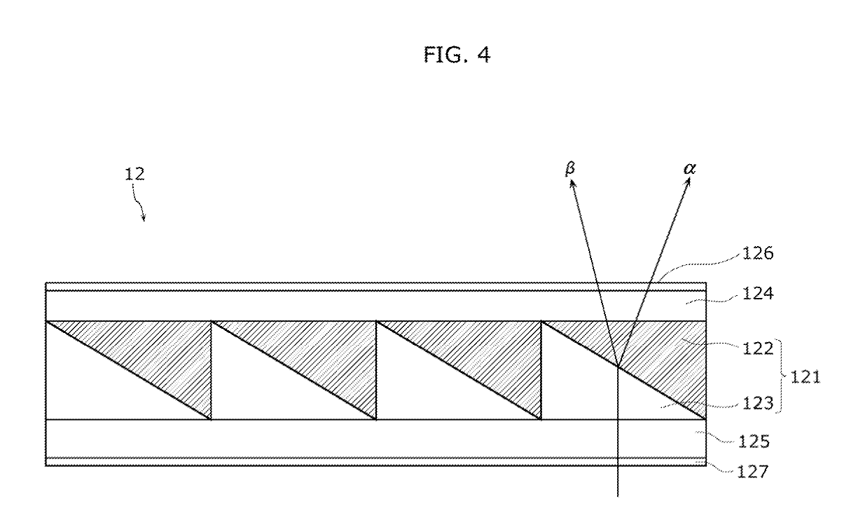

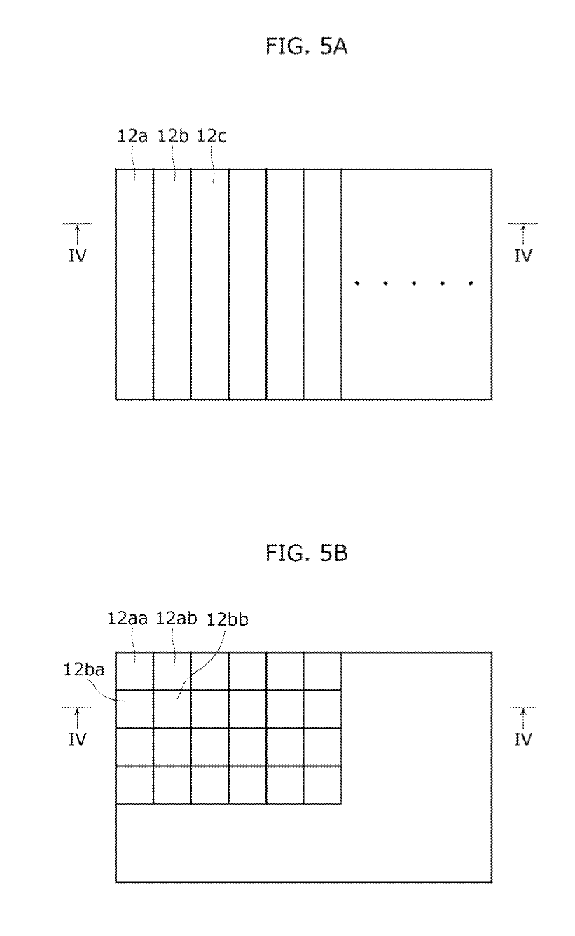

The deflection unit 12 deflects a light beam emitted from the light source 11 in a predetermined direction and the deflected light beam enters into the image display unit 13. More specifically, the deflection unit 12 includes plural regions and deflects the light beam traveling from the light source 11 toward the image display unit 13 for each of the regions. The specific structure of the deflection unit 12 will be described later with reference to FIG. 4, FIG. 5A, and FIG. 5B.

The image display unit 13 includes plural pixels arranged in a matrix, and displays an image received by the image reception unit 14. The image display unit 13 is not particularly limited to a specific structure, but is a unit which displays an image by controlling an amount of the light beam passing through the unit from the back light (the light source 11), and the unit typically corresponds to a liquid crystal panel.

The image reception unit 14 receives image data (including video data, the same shall apply hereinafter) to be displayed on the image display device 10. A source of the image data is not particularly limited to a specific source, but the image reception unit 14 may receive the image data from broadcast wave, a content server on the Internet via a communication network, or a recording medium such as an hard disk drive (HDD), a digital versatile disc (DVD), or a Blu-ray Disc (BD), for example.

A detection unit 15 detects an eye position of a viewer watching an image displayed on the image display device 10. Then, the detection unit 15 informs a deflection control unit 162 about the detected eye position. The detection unit 15 is not particularly limited to a specific structure, but may be a camera capable of capturing an area where a screen of the image display device 10 can be seen, as shown in FIG. 1, for example. In addition, when more accurate detection of the eye position is needed, a stereo camera may be used,

It should be noted that the image display device 10 need not necessarily include a camera. In other wards, the detection unit 15 may include an interface for connecting to an external camera to detect the eye position of the viewer by analyzing the image data received from the camera through the interface.

The light control unit 16 controls the deflection unit 12. More specifically, as shown in FIG. 2, the light control unit 16 includes a pixel determination unit 161 and the deflection control unit 162, and controls the deflection unit to cause each of light beams passing through a corresponding one of the regions of the deflection unit 12 to be deflected toward the first point or the second point which are different from each other, according to a pixel value of the pixel corresponding to the region.

The pixel determination unit 161 receives image data of an image to be displayed on the image display unit 13, and determines a pixel value of each of pixels in the image display unit 13. More specifically, the pixel determination unit 161 determines whether a luminance value of each pixel is not less than or less than a predetermined value. More specifically, the pixel determination unit 161 determines whether the pixel appears black or almost black, or the other colors.

The predetermined threshold is not particularly limited to a specific value, but may be a total of RGB values (for example, 30, preferably 20, further preferably 5) when the pixel value of the pixel is represented by RGB data. Alternatively, when the pixel value of the pixel is represented by a luminance value (Y) and a color difference value (Cb, Cr), the predetermined threshold may be the luminance value (Y) (for example, 10, preferably 5, further preferably 3).

The deflection control unit 162 receives the result of determining the pixel value of the pixel from the pixel determination unit 161, and also receives the eye position of the viewer from the detection unit 15. Then, the deflection control unit 162 controls the deflection unit 12 for each of the regions so that the light beam passing through a region of the deflection unit 12 corresponding to a pixel having a luminance value not less than a predetermined threshold is deflected toward the first point and the light beam passing through a region of the deflection unit 12 corresponding to a pixel having a luminance value less than the threshold is deflected toward the second point.

Typically, the first point is the eye position of the viewer, and the second point is a position outside positions of both eyes of the viewer. In other words, the deflection control unit 162 controls the deflection unit 12 so that light beams passing through almost black pixels are collected to the position outside positions of the eyes of the viewer and light beams passing through color pixels other than the almost black pixels are collected to the eye position of the viewer.

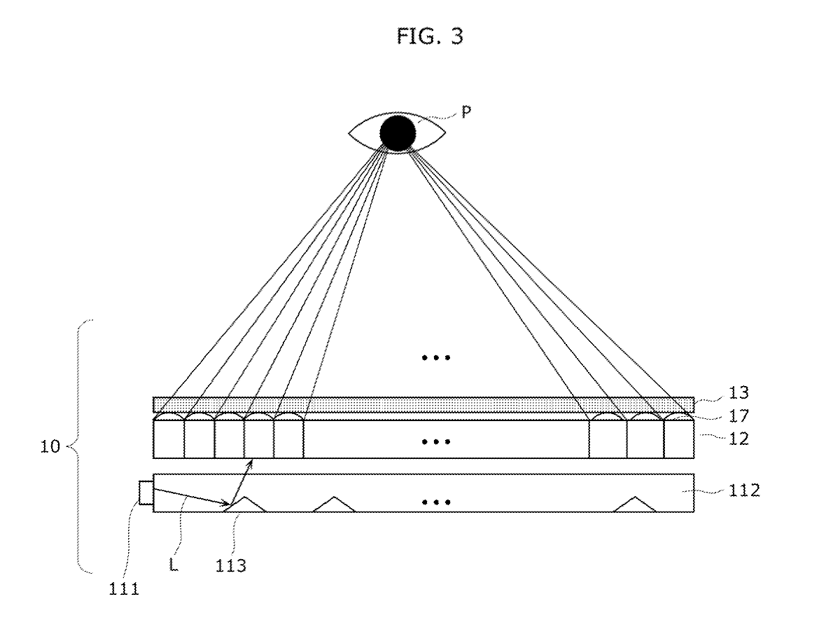

Next, FIG. 3 illustrates a diagram showing a configuration of the light source 11, the deflection unit 12, and the image display unit 13. The light source 11 includes a solid-state RGB laser system 111 and a light guide plate 112 for example. Three color light beams L emitted from the solid-state RGB laser system 111 are uniformly diffused throughout the light guide plate 112 while undergoing successive total reflections in it. In addition, a bottom surface of the light guide plate 112 has structural objects 113 arranged in a regular manner, and the light beams L reflected from the structural objects 113 pass upward through the light guide plate 112 because the reflected light beams L violate total reflection condition. The light beams L having passed through the light guide plate 112 enter into the deflection unit 12 provided above the light guide plate 112.

FIG. 4 illustrates a diagram showing a specific structure of the deflection unit 12. The deflection unit 12 can control a deflection direction of light by changing orientations of liquid crystal molecules. As shown in FIG, 4, the deflection unit 12 includes a liquid crystal deflection element 121, a pair of transparent base members 124 and 125 with the liquid crystal deflection element 121 being provided therebetween, and a pair of transparent electrodes 126 and 127 sandwiching the pair of transparent base members 124 and 125.

The liquid crystal deflection element 121 has liquid crystal portions 122 each being triangular in cross-section and dielectric portions 123 each having a complementary shape to the liquid crystal portion 122. As a whole, the liquid crystal deflection element 121 is rectangular in cross-section because a hypotenuse face of a liquid crystal portion 122 and a hypotenuse face of a dielectric portion 123 are in contact with each other.

The transparent base member 124 and the transparent base member 125 are provided on one surface of the liquid crystal deflection element 121 (facing to the image display unit 13) and the other (facing to the light source 11), respectively. In addition, a transparent electrode 126 is provided on a surface of the transparent base member 124, which is opposite to a surface in contact with the liquid crystal deflection element 121. Meanwhile, a transparent electrode 127 is provided on a surface of the transparent base member 125, which is opposite to a surface in contact with the liquid crystal deflection element 121.

In other wards, the transparent base member 124 holds the liquid crystal deflection element 121 on one surface (a lower surface in FIG. 4) and also holds the transparent electrode 126 on the other (an upper surface in FIG. 4). Similarly, the transparent base member 125 holds the liquid crystal deflection element 121 on one surface (an upper surface in FIG. 4) and also holds the transparent electrode 127 on the other (a lower surface in FIG. 4).

The dielectric portion 123 can be made of a polymer material such as plastic or a glass material for example. The dielectric portion 123 is also made of a material having a refractive index substantially equal to the refractive index in one oriented state of the liquid crystal portion 122 (for example, an oriented state of the liquid crystal portion 122 in which a voltage is not applied across the pair of transparent electrodes 126 and 127).

In other words, when a voltage is not applied across the pair of transparent electrodes 126 and 127, the light beam passing through the liquid crystal deflection element 121 travels in a straight line. On the other hand, when a voltage is applied across the pair of transparent electrodes 126 and 127, the refractive index of the liquid crystal portion 122 is modulated and the light beam passing through the liquid crystal deflection element 121 is deflected in a predetermined direction.

More specifically, when the refractive index of the liquid crystal portion 122 NL is higher than a refractive index of the dielectric portion 123 ND, the light beam is deflected in a direction such as an arrow o in FIG. 4. On the other hand, when the refractive index of the liquid crystal portion 122 NL is lower than a refractive index of the dielectric portion 123 ND, the light beam is deflected in a direction such as an arrow β shown in FIG. 4. Thus, a deflection angle of light can be modulated by controlling the voltage to be applied across the pair of transparent electrodes 126 and 127.

In addition, the deflection unit 12 is divided into plural regions. The pair of transparent electrodes 126 and 127 is capable of applying a different voltage to each of the regions, In other words, the light beam passing through each region can be deflected in a different direction. The deflection control unit 162 in FIG. 2 applies a predetermined voltage across the pair of transparent electrodes 126 and 127 for each region so that the light beam passing through the region of the deflection unit 12 is deflected in a desired direction.

Both FIG. 5A and 5B illustrate an example of the deflection unit 12 divided into plural regions. As shown in FIG. 5A, the deflection unit 12 may be divided into rectangular regions, 12a, 12b, 12c, and more, each extending in a longitudinal direction (a stripe pattern). Alternatively, as shown in FIG. 5B, the deflection unit 12 may be divided into a matrix of regions. Both a cross sectional view of FIG. 5A along the line IV-IV and a cross sectional views of FIG. SB along the line IV-IV correspond to FIG. 4. It should be noted that a method of dividing the deflection unit 12 is not limited to these methods.

Condenser lenses 17 are provided above the deflection unit 12. Each of the condenser lenses 17 further deflects the light beam having passed through a corresponding one of the regions of the deflection unit 12. The image display unit 13 is provided above the condenser lenses 17. The image display unit 13 includes plural pixels arranged in a matrix, electrodes which determine the luminance of each of the pixels based on a desired input image signal, a driving unit (a driver), and so on (not shown). Light beams passing through the image display unit 13 are collected to a light-collecting point P shown in FIG. 3 for example.

It should be noted that there is a one-to-one relationship or a one-to-many relationship between the regions of the deflection unit 12 and the pixels of the image display unit 13. In other words, the total number of pixels of the image display unit 13 is equal to or more than the total number of regions of the deflection unit 12. Consequently, the light beam having passed through one region of the deflection unit 12 enters into one or more pixels of the image display unit 13. Thus, the one or more pixels into which the light beam having passed through one region is entered are referred to as a pixel corresponding to a region or pixels corresponding to a region.

According to the above configuration, the light beams passing through the deflection unit 12, the condenser lenses 17, and the image display unit 13 can be collected to a given light-collecting point P. The given light-collecting point P corresponds to an eye position of a viewer watching an image displayed on the image display device 10.

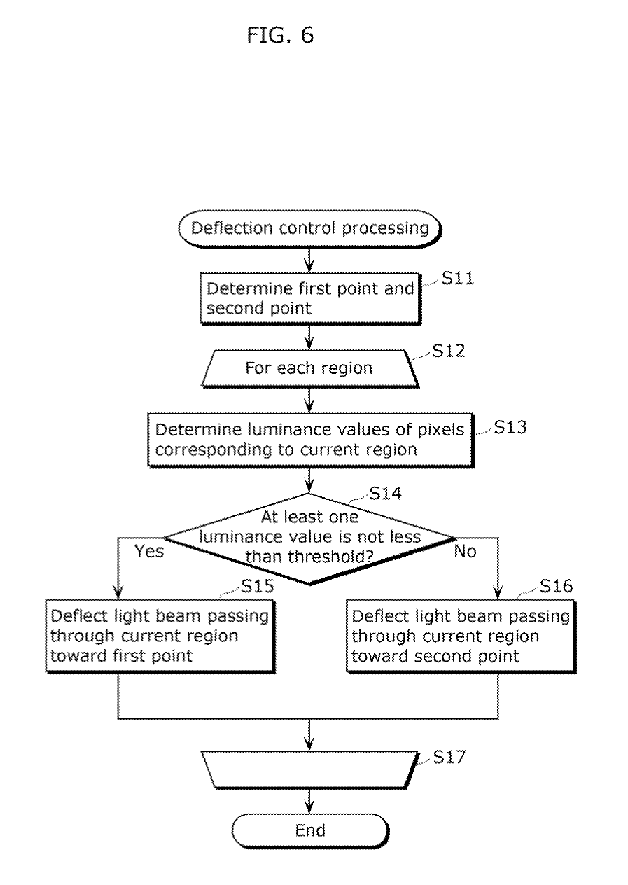

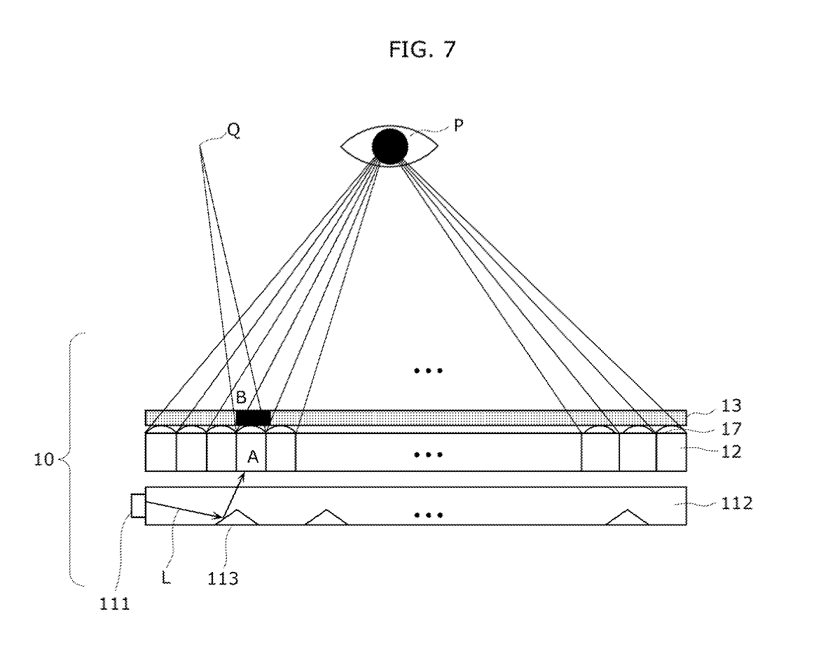

Luminance of the image displayed on the image display unit 13 can be improved by collecting the light beams passing through the image display unit 13 to an eye of the viewer. As a result, power of the light source 11 can be minimized and thus contributing to electrical power saving. Here, an example of a method of effectively controlling the deflection unit 12 according to a pixel value of each of the pixels in the image display unit 13 is described with reference to FIG. 6 and FIG. 7.

First, the deflection control unit 162 of the light control unit 16 determines the first point and the second point (S11). More specifically, the deflection control unit 162 determines the eye position of the viewer detected by the detection unit 15 as the first point, and a position outside positions of both eyes of the viewer as the second point. In other words, in the example shown in FIG. 7, the light-collecting point P is the first point, and the light-collecting point Q is the second point.

Next, the light control unit 16 executes Steps S12 to S17 shown in FIG. 6 for each of the regions of the deflection unit 12. Upon receiving image data from the image reception unit 14, the pixel determination unit 161 determines a pixel value (a luminance value) for each of the pixels corresponding to a current region (S13).

When at least one of the pixels corresponding to the current region have a luminance value that is not less than the threshold (S14 is Yes), the deflection control unit 162 applies a predetermined voltage across the pair of transparent electrodes 126 and 127 in the current region so that the light beam passing through the current region is deflected toward the light-collecting point P (the first point) (S15), Meanwhile, when each of all the pixels corresponding to the current region has a luminance value that is less than the threshold (S14 is No), the deflection control unit 162 applies a predetermined voltage across the pair of transparent electrodes 126 and 127 in the current region so that the light beam passing through the current region is deflected toward the light-collecting point Q (the second point) (S16).

FIG. 7 illustrates light-collecting positions for light beams passing through the respective regions of the deflection unit 12 when a set of pixels B in the image display unit appears black (luminance is less than a predetermined threshold). When the set of pixels B appears black, a light beam passing through a region A of the deflection unit 12 corresponding to the set of pixels B is deflected so as to be collected to the light-collecting point Q instead of the light-collecting point P. On the other hand, light beams passing through the other regions are deflected so as to be collected to the light-collecting point P. Note that the light-collecting point Q need not be at a specific position. It should be different from the light-collecting point P to which the light beams passing through the other regions are collected. In other words, more than one light-collecting points Q may exist,

When the set of pixels B appears black, a typical liquid crystal panel controls the set of pixels B by changing orientations of liquid crystal molecules in it so as to have the least amount of the light beam passing through it. However, a part of the light beam passes through the liquid crystal panel and reaches a viewer's eye, and which reduces contrast of an image. In view of this, in order to prevent even a slight amount of the light beam passing through the set of black pixels B from being collected to the viewer's eye, the light control unit 16 according to the embodiment 1 deflects the light beam passing through the region A to the light-collecting point Q different from the light-collecting point P. This allows the light beam passing through the set of pixels B not to reach the viewer's eye. As a result, a wider dynamic range of the contrast of the image and a higher image quality can be achieved.

In the embodiment 1, the solid-state RGB laser system 111 is used as the light source 11, but not limited to this. For example, the light source may be a LED light source, and the light beams of R, G, and B need not have different light sources. In other words, the light source may be a light source of single white false color.

The light source 11 may include one or more solid-state RGB laser systems 111. However, the image display method according to the embodiment 1 exerts a significant effect when the number of pixels of the image display unit 13 is extremely greater than the number of light sources (which are the solid-state RGB laser system 111 in FIG. 3), for example, when the number of pixels is more than or equal to ten times the number of light sources.

In addition, it does not matter whether the viewer's eye is a left eye or a right eye. The light beams are collected to one eye in the above-mentioned example, but the present invention is not limited to this. Furthermore, with regards to a light-collecting region, at least a part of the light beam should reach a pupil, In other words, the light beams should be collected to a predetermined region including the eye position of the viewer. The light-collecting region may also include not only one eye but also both eyes. Alternatively, the deflection unit 12 may be controlled in a time-division manner so that the light beams are collected to a left eye (a right eye) during a period of time and then the light beams are collected to a right eye (a left eye) during the next period of time,

Moreover, the embodiment 1 describes that the light beam passing through one region is deflected toward the second point when each of all the pixels corresponding to the region has a luminance value less than the threshold, but the present invention is not limited to this. For example, the light beam passing through one region may be deflected toward the second point when each of a predetermined percentage (half, 80%, or the like) of the pixels corresponding to the region have a luminance value less than the threshold. Instead, it may be possible to compare the threshold with an average of the pixel values of the pixels corresponding to one region (or the pixel value of the brightest pixel).

### Embodiment 2

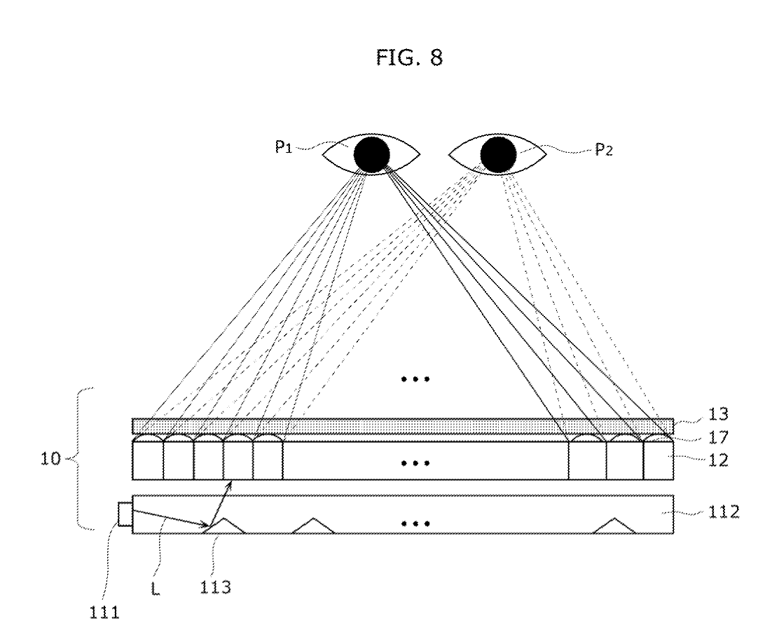

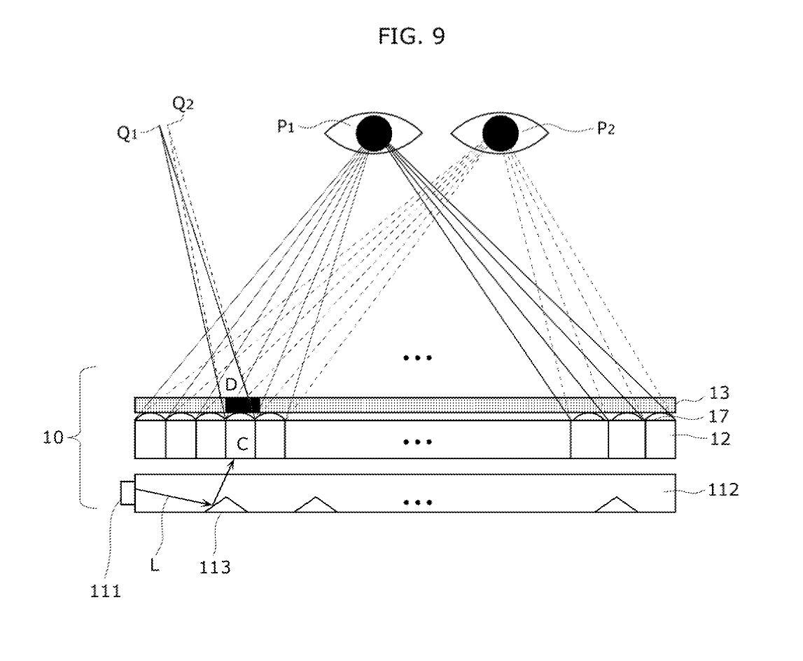

An image display device according to an embodiment 2 is described with reference to FIG. 8 and FIG. 9. It should be noted that the following paragraphs describe the differences between the embodiment 1 and the embodiment 2, and details of the same are omitted from the description herein. The basic configuration of the image display device according to the embodiment 2 is the same as that of the image display device according to the embodiment 1 as shown in FIG. 1 to FIG. 5B.

FIG. 8 illustrates light-collecting positions for light beams emitted from the image display device according to the embodiment 2. The image display device 10 according to the embodiment 2 alternately displays a right-eye image and a left-eye image based on which a three-dimensional image is produced, and causes light beams for the right-eye image to be collected to a right-eye position of a viewer and light beams for the left-eye image to be collected to a left-eye position of the viewer.

When a three-dimensional image is displayed, the right-eye image and the left-eye image are sequentially and alternatively displayed on the image display unit 13. The right-eye image is an image captured by the right eye. The left-eye image is an image captured by the left eye. In other words, the right-eye image and the left-eye image have different visual angles, and thus the images have disparity. A viewer can see an image in three-dimensional by sequentially displaying such right-eye and left-eye images and collecting the light beams to only the right eye of the viewer when the right-eye image is displayed and to only the left eye when the left-eye image is displayed,

It should be noted that three-dimensional image data may be image data captured from the two different points as mentioned above, or may be produced using computer graphics. The image reception unit 14 may receive image data including the right-eye image and the left-eye image, or produce a three-dimensional image (the right-eye image and the left-eye image) from the received two-dimensional image.

The light control unit 16 controls, at a time when the right-eye image appears on the image display unit 13, a voltage and a refractive index of a liquid crystal layer for each region of the deflection unit 12 so as to cause light beams from the image display device 10 to be collected to the right-eye position of the viewer. Here, the right-eye position and left-eye position of the viewer can be identified from an image captured by a camera provided in the image display device 10.

The light control unit 16 also controls, at a time when the left-eye image appears on the image display unit 13, the voltage and the refractive index of the liquid crystal layer for each region of the deflection unit 12 so as to cause the light beams from the image display device 10 to be collected to the left-eye position of the viewer. Thus, the light control unit 16 controls the deflection unit 12 in synchronization with switching between images to be displayed on the image display unit 13.

In such a configuration, an effective method of controlling the deflection unit 12 is described with reference to FIG. 9, FIG. 9 illustrates light-collecting positions for light beams passing through the respective regions of the deflection unit 12 when a set of pixels D in the image display unit 13 appears black (luminance is less than a predetermined threshold).

When the set of pixels D appears black, the light control unit 16 controls the deflection unit 12 so as to cause a light beam passing through a region C of the deflection unit 12 corresponding to the set of pixels D to be deflected toward light-collecting points Q₁ and Q₂ instead of light-collecting points P₁ and P₂ which represent positions of both eyes of the viewer. Note that the light-collecting points Q₁ and Q₂ need not be at specific positions. They should be different from the light-collecting points P₁ and P₂ to each of which the light beams passing through the other regions are collected.

More specifically, the light control unit 16 controls the deflection unit 12 at a time when the right-eye image appears on the image display unit 13, so as to cause a light beam passing through the set of black pixels D to be deflected toward the light-collecting point. Q₁ and light beams passing through the other pixels toward the light-collecting point P₁. The light control unit 16 also controls the deflection unit 12 at a time when the left-eye image appears on the image display unit 13, so as to cause a light beam passing through the set of black pixels D to be deflected toward the light-collecting point Q₂ and light beams passing through the other pixels toward the light-collecting point P₂.

It should be noted that the embodiment 2 describes the image display device allows a viewer to see an image in three-dimensional by alternatively displaying the right-eye image and the left-eye image in a time-division manner, but the present invention is not limited to this. For example, the right-eye image and the left-eye image may be simultaneously displayed on the image display unit 13 which is spatially divided. More specifically, the image display unit 13 displays the right-eye image on a part of the pixels and the left-eye image on the remaining pixels. Then, the light control unit 16 controls the deflection unit 12 so as to cause light beams passing through the pixels for the right-eye image to be collected to the light-collecting point P₁ and light beams passing through the pixels for the left-eye image to the light-collecting point P₂.

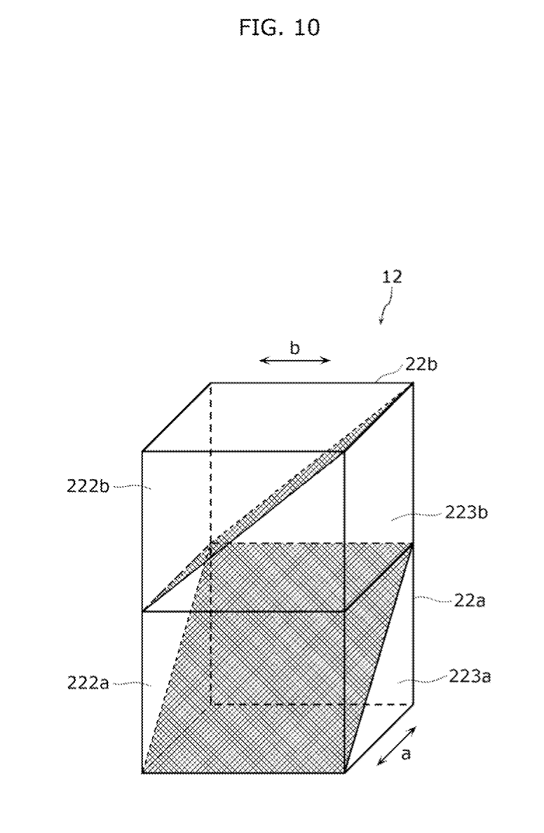

In addition, both of the embodiments 1 and 2 describe that the light beam passing through the deflection unit 12 is deflected only in a horizontal direction, but the present invention is not limited to this, and it is possible to cause the light beam to be deflected in a horizontal direction, a vertical direction, or any combination of the directions. For example, as shown in FIG. 10, the light beam can be deflected in any direction by forming the deflection unit 12 including a first sub-deflection unit 22a and a second sub-deflection unit 22b in combination.

FIG. 10 illustrates a perspective view showing one of regions of a set of the first sub-deflection unit 22a and the second sub-deflection unit 22b. The deflection unit 12 shown in FIG. 10 is formed by vertically stacking the first sub-deflection unit 22a and the second sub-deflection unit 22b. It should be noted that the basic configuration of both the first sub-deflection unit 22a and the second sub-deflection unit 22b is the same as that of the deflection unit 12 shown in FIG. 4, and a detailed description is omitted here.

A shaded plane in the first sub-deflection unit 22a represents an interface between a liquid crystal portion 222a and a dielectric portion 223a. This interface is inclined to a direction of an arrow a shown in FIG. 10 (a first direction). Similarly, a shaded plane in the second sub-deflection unit 22b represents an interface between a liquid crystal portion 222b and a dielectric portion 223b. This interface is inclined to a direction of an arrow b shown in FIG. 10 (a second direction). The fist direction and the second direction are crossing (orthogonal to) each other.

The lower first sub-deflection unit 22a deflects, in the first direction, the light beam emitted from the light source 11 (not shown in FIG. 10). The upper second sub-deflection unit 22b also deflects, in the second direction, the light beam having passed through the first sub-deflection unit 22a, and then the deflected light beam goes to the image display unit 13 (not shown in FIG. 10). In other words, the light control unit 16 allows the light beam passing through the deflection unit 12 to be deflected in any direction, by applying predetermined voltages to the first sub-deflection unit 22a and the second sub-deflection unit 22b, respectively.

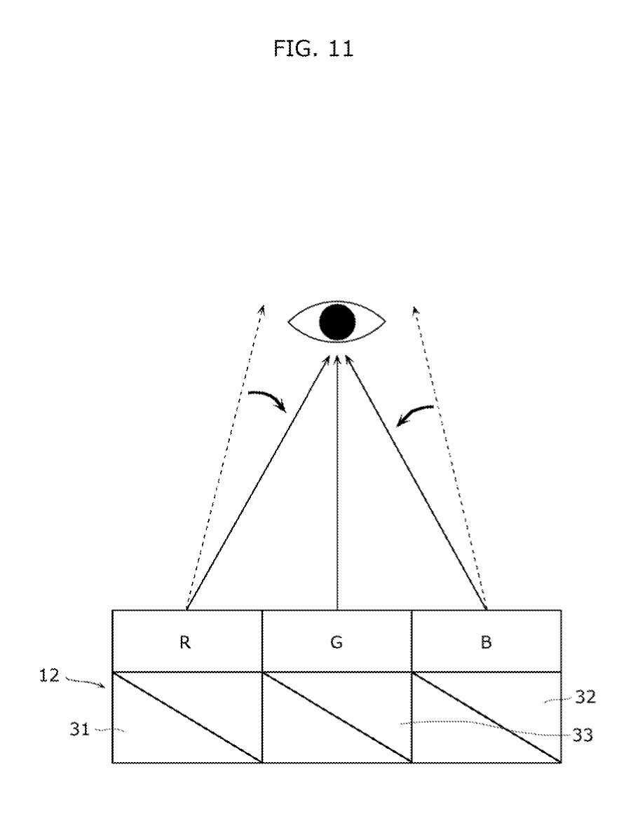

In addition, the embodiments 1 and 2 describe that a region of the deflection unit 12 has a size equal to or more than a size of a pixel in the image display unit 13, as an example, but, as shown in FIG. 11, the region may be further divided into plural sub-regions to cause the light beam to be deflected for each of the sub-regions. FIG. 11 illustrates an example of a region of the deflection unit 12, which is divided into sub-regions each provided for a corresponding one of sub-pixels.

First, one of the pixels of the image display unit 13 includes n sub-pixels (n is an integer not less than 2). One of the regions of the deflection unit 12 includes n sub-regions 31, 32, and 33 (n=3 in

FIG, 11) provided for different sub-pixels of a corresponding one of the pixels.

More specifically, the pixel shown in FIG. 11 includes three sub-pixels of Red (R), Green (G), and Blue (B). These sub-pixels can be implemented by using color filters of RGB. The region of the deflection unit 12 includes the sub-region 31 corresponding to the red sub-pixel, the sub-region 32 corresponding to the green sub-pixel, and the sub-region 33 corresponding to the blue sub-pixel.

Here, when the light beam passing through each sub-pixel is deflected by the deflection unit 12 not divided into the sub-regions (for example, the deflection unit in FIG. 4), three color light beams are not collected to one point (the light-collecting point P) due to different characteristics for wavelengths of RGB colors. In FIG. 11, although the light beam passing through the green sub-pixel reaches the light-collecting point P, the light beam passing through the red sub-pixel goes off to the left of the light-collecting point P, and the light beam passing through the blue sub-pixel goes off to the right of the light-collecting point P (see dashed arrows).

In view of this, in FIG. 11, in order to collect all color light beams to the light-collecting point P by absorbing such different characteristics for wavelengths of RGB colors, the light control unit 16 separately controls the sub-regions 31, 32, and 33 to cause the light beams to be deflected. In other words, the light control unit 16 applies predetermined voltages to the sub-regions 31, 32, and 33, respectively, so that the light beam passing through the sub-region 31 corresponding to the red sub-pixel is further deflected to the right of the dashed arrow, and the light beam passing through the sub-region 33 corresponding to the blue sub-pixel is further deflected to the left of the dashed arrow. With this, the light beams passing through respective sub-pixels can be collected to one point.

Although the present invention has been described according to the above-mentioned embodiments, it is needless to say that the present invention is not limited to such embodiments. The present invention includes the following cases:

(1) The aforementioned each device can be implemented by a computer system including, specifically, a microprocessor, a ROM, a RAM, a hard disk unit, a display unit, a keyboard, a mouse, and the so on. A computer program is stored in the RAM or hard disk unit. The device achieves the function through the microprocessor's operation according to the computer program. The computer program is configured by combining plural instruction codes indicating instructions for the computer in order to achieve the predetermined function;

(2) A part or all of the constituent elements included in the device may be configured of one system large scale integration (LSI). The system LSI is a super multi-function LSI that is manufactured by integrating plural components in one chip, and is specifically a computer system which is configured by including a microprocessor, a ROM, a RAM, and so on. A computer program is stored in the ROM. The system LSI accomplishes its functions through the operation of the microprocessor in accordance with the computer program loaded from ROM to RAM by the microprocessor;

(3) A part or all of the constituent elements constituting the device may be configured as an IC card which can be attached and detached from the respective apparatuses or as a stand-alone module. The IC card or the module is a computer system configured from a microprocessor, a ROM, a RAM, and the so on. The IC card or the module may also be included in the aforementioned super-multi-function LSI. The IC card or the module achieves its function through the microprocessor's operation according to the computer program. The IC card or the module may also be implemented to be tamper-resistant.

In other words, an integrated circuit according an embodiment of the present invention causes an image display device to display an image, the image display device including: a light source; an image display unit which includes plural pixels and controls, for each of the plural pixels, an amount of a light beam passing through the pixel from the light source; and a deflection unit includes plural regions and deflects, for each of the plural regions, a light beam traveling from the light source toward the image display unit. This integrated circuit includes a light control unit which controls the deflection unit to cause each of light beams passing through a corresponding one of the regions of the deflection unit to be deflected toward one of a first point and a second point, according to a pixel value of the pixel corresponding to the region, the first point and the second point being different from each other.

(4) The present invention may be achieved by the aforementioned method. In addition, the present invention may be achieved by a computer program for realizing such a method using a computer, or a digital signal including the computer program.

In other words, an image display method according to an embodiment of the present invention causes an image display device to display an image, the image display device including: a light source; an image display unit which includes plural pixels and controls, for each of the plural pixels, an amount of a light beam passing through the pixel from the light source; and a deflection unit which includes plural regions and deflects, for each of the plural regions, a light beam traveling from the light source toward the image display unit. This image display method includes controlling the deflection unit to cause each of light beams passing through a corresponding one of the regions of the deflection unit to be deflected toward one of a first point and a second point, according to a pixel value of the pixel corresponding to the region, the first point and the second point being different from each other.

Furthermore, the present invention may also be realized by storing the computer program or the digital signal in a computer readable recording medium such as flexible disc, a hard disk, a CD-ROM, an MO, a DVD, a DVD-ROM, a DVD-RAM, a BD (Blu-ray Disc), and a semiconductor memory. Furthermore, the present invention also includes the digital signal recorded in these recording media.

Furthermore, the present invention may also be realized by the transmission of the aforementioned computer program or digital signal via a telecommunication line, a wireless or wired communication line, a network represented by the Internet, a data broadcast and so on.

The present invention may also be a computer system including a microprocessor and a memory, in which the memory stores the aforementioned computer program and the microprocessor operates according to the computer program,

Furthermore, by transferring the program or the digital signal by recording onto the aforementioned recording media, or by transferring the program or digital signal via the aforementioned network and the like, execution using another independent computer system is also made possible; and

(5) Any combination of the embodiments and the variations may be possible.

The embodiments of the present invention are described above with reference to the drawings, but the present invention is not limited to such embodiments. The above embodiments can be modified or altered within the same or equivalent scope of the present invention.

### INDUSTRIAL APPLICABILITY

An image display device according to the present invention can improve image contrast and image quality by effectively deflecting light beams, and can be broadly applicable to display devices, In addition, when the image display device is used for a display device such as a 3D liquid crystal display device or a privacy display, it can be implemented with a simple configuration, and that is useful.

### REFERENCE SIGNS LIST

10 Image display device
11 Light source
12 Deflection unit
12a, 12b, 12c, 12aa, 12ab, 12ba, 12bb Region
13 Image display unit
14 Image reception unit
15 Detection unit
16 Light control unit
17 Condenser lens
22a First deflection unit
22b Second deflection unit
31, 32, 33 Sub-region
111 Solid-state RGB laser
112 Light guide plate
113 Structural object
121 Liquid crystal deflection element
122, 222a, 222b Liquid crystal portion
123, 223a, 223b Dielectric portion
124, 125 Transparent base member
126, 127 Transparent electrode
161 Pixel determination unit
162 Deflection control unit

1. An image display device comprising:
a light source;
an image display unit including plural pixels and configured to control, for each of the plural pixels, an amount of a light beam passing through the pixel, the light beam being emitted from the light source;
a deflection unit including plural regions and configured to deflect, for each of the plural regions, a light beam traveling from the light source toward the image display unit; and
a light control unit configured to control the deflection unit to cause each of light beams passing through a corresponding one of the regions of the deflection unit to be deflected toward one of a first point and a second point, according to a pixel value of the pixel corresponding to the region, the first point and the second point being different from each other.

2. The image display device according to claim 1,
wherein the light control unit is configured to cause a first light beam and a second light beam to be deflected toward the first point and the second point, respectively, the first light beam being a light beam passing through the region corresponding to the pixel having a luminance value not less than a predetermined threshold, and the second light beam being a light beam passing through the region corresponding to the pixel having a luminance value less than the threshold.

3. The image display device according to claim 1, further comprising
a detection unit configured to detect an eye position of a viewer,
wherein the light control unit is configured to determine the eye position of the viewer detected by the detection unit as the first point, and a position outside positions of both eyes of the viewer as the second point.

4. The image display device according to claim 3,
wherein the image display device alternately displays a right-eye image and a left-eye image which have disparity, and
the light control unit is configured to:
determine a right-eye position of the viewer detected by the detection unit as the first point at a time when the right-eye image appears; and
determine a left-eye position of the viewer detected by the detection unit as the first point at a time when the left-eye image appears.

5. The image display device according to claim 1,
wherein the deflection unit includes:
a first sub-deflection unit configured to deflect, in a first direction, the light beam emitted from the light source; and
a second sub-deflection unit configured to deflect, in a second direction, the light beam having passed through the first sub-deflection unit, the second direction being a direction crossing the first direction.

6. The image display device according to claim 1,
wherein the region includes n sub-regions each provided for a corresponding one of n sub-pixels of the pixel, n being an integer not less than 2, and
the light control unit is configured to separately control deflection angles of the n sub-regions to cause each of light beams passing through a corresponding one of the n sub-regions to be deflected toward the first point.

7. The image display device according to claim 1,
wherein the image display unit is a liquid crystal panel.

8. The image display device according to claim 1,
wherein the deflection unit is configured to control a deflection direction by changing orientations of liquid crystal molecules.

9. The image display device according to claim 1,
wherein the image display device includes a plurality of the light sources, and
the image display unit includes the plural pixels, the total number of which is more than or equal to ten times the total number of the light sources.

10. An image display method for causing an image display device to display an image, the image display device including: a light source; an image display unit including plural pixels and configured to control, for each of the plural pixels, an amount of a light beam passing through the pixel from the light source; and a deflection unit including plural regions and configured to deflect, for each of the plural regions, a light beam traveling from the light source toward the image display unit, the image display method comprising
controlling the deflection unit to cause each of light beams passing through a corresponding one of the regions of the deflection unit to be deflected toward one of a first point and a second point, according to a pixel value of the pixel corresponding to the region, the first point and the second point being different from each other.

11. An integrated circuit for causing an image display device to display an image, the image display device including: a light source; an image display unit including plural pixels and configured to control, for each of the plural pixels, an amount of a light beam passing through the pixel from the light source; and a deflection unit including plural regions and configured to deflect, for each of the plural regions, a light beam traveling from the light source toward the image display unit, the integrated circuit comprising
a light control unit configured to control the deflection unit to cause each of light beams passing through a corresponding one of the regions of the deflection unit to be deflected toward one of a first point and a second point, according to a pixel value of the pixel corresponding to the region, the first point and the second point being different from each other.
